(19) United States
(12) Patent Application Publication
(10) Pub. No.: US 2010/0124925 A1
(43) Pub. Date: May 20, 2010

(54) Network search method and system for mobile station

(75) Inventors: Hyoung Kwon Kim, Seoul (KR); In Hoe Koo, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/590,278

(22) Filed: Nov. 4, 2009

(30) Foreign Application Priority Data
Nov. 14, 2008 (KR) 10-2008-0113123

(51) Int. Cl. H04W 4/00

(52) U.S. Cl. 455/435.1

(57) ABSTRACT

A system and method for a network search by a mobile station enable the mobile station to reduce power consumption by performing a local network search on the basis of a system information message from a mobile communication network. The network search method in a wireless communication system includes: broadcasting, by a mobile communication network, a system information message containing information regarding the presence of a local network (access point information); and performing, after reception of the system information message, by a mobile station, network search for a local network according to the access point information.

### CROSS-REFERENCE TO RELATED APPLICATION(S) AND CLAIM OF PRIORITY

The present application is related to and claims priority to an application entitled “NETWORK SEARCH METHOD AND SYSTEM FOR MOBILE STATION” filed in the Korean Intellectual Property Office on Nov. 14, 2008 and assigned Serial No. 10-2008-0113123, the contents of which are incorporated herein by reference.

### TECHNICAL FIELD OF THE INVENTION

The present invention relates generally to a network search method and system in a wireless communication environment and, more particularly, to a network search method and system that enable a mobile station to reduce power consumption due to unnecessary local network search on the basis of a system information message from a mobile communication network.

### BACKGROUND OF THE INVENTION

Recent advances in wireless communication techniques have persuaded numerous individuals who previously utilized wired networks to adopt wireless networks. That is, wireless networks overcome mobility limitations inherent in wired networks. Among many types of wireless technologies, technologies for a mobile communication network, a wireless local network, and interoperability between a mobile communication network and wireless local network have been actively developed.

An advanced wireless network enables high-speed data transmission and permits users in motion to receive a mobile communication service, high-speed data service, and Internet Protocol (IP) based service.

A mobile station may have multiple wireless communication modules to receive various services from a wireless network. That is, the mobile station may connect to a wireless network through the wireless communication modules to communicate with a desired server and another mobile station, and to receive a mobile communication service and Internet service.

Currently, a wireless network can include a mobile communication network (such as a global system for mobile communications (GSM) network, universal mobile telecommunications system (UMTS) network, international mobile telecommunications 2000 (IMT 2000) network, code division multiple access (CDMA) network, or wideband CDMA (WCDMA) network), and a wireless local network (such as IEEE 802.11 WLAN), where the service areas of the mobile communication network and wireless local network may overlap each other.

A wireless local network and mobile communication network can have contrasting properties. For example, the wireless local network can provide high-speed and low-cost services with a narrow service area and low mobility. The mobile communication network can provide low-speed and high-cost services with a wide service area and high mobility.

For this reason, convergence technologies are currently underdevelopment to combine a mobile communication network and local network for interoperability, and multi-mode mobile stations supporting multiple radio access technologies (RAT) are also under development to access both a mobile communication network and local network.

A multi-mode mobile station can use a high-speed IP-based wireless service such as Portable Internet through an access point (AP) of a local network.

Compared with base stations in a mobile communication network, as access points of a local network may not be densely installed, the local network can provide only a narrow coverage area. Local network access points tend to be installed only in some selected cells of the mobile communication network. That is, currently, many cells of the mobile communication network may not have a local network access point.

To receive a wireless service from a local network, a multi-mode mobile station may have to repeat a local network search until an adequate access point is found. Even in the case when a local network access point is not present in the current cell, the multi-mode mobile station may perform a local network search, resulting in unnecessary power consumption.

### SUMMARY OF THE INVENTION

To address the above-discussed deficiencies of the prior art, it is a primary object to provide a network search method and system that enable a mobile station to efficiently reduce power consumption due to network search.

The present invention also provides a network search method and system that enable a mobile station to reduce power consumption due to network search by shortening the network search time.

The present invention further provides a network search method and system for a mobile station wherein the mobile station can check the presence of a local network on the basis of a system information message from a mobile communication network, and skip a network search if a local network is not present, thereby reducing power consumption due to unnecessary network search.

In accordance with an exemplary embodiment of the present invention, there is provided a network search method in a wireless communication system, including: broadcasting, by a mobile communication network, a system information message containing information regarding the presence of a local network (access point information); and performing, after reception of the system information message, by a mobile station, network search for a local network according to the access point information.

In accordance with another exemplary embodiment of the present invention, there is provided a network search method of a mobile station, including: camping on a mobile network cell of a mobile communication network, and receiving a system information message broadcast from the mobile network cell; checking access point information in the received system information message; and determining whether to perform network search for a local network according to the value of the access point information.

In accordance with another exemplary embodiment of the present invention, there is provided a wireless communication system including: a mobile station; a mobile communication network; and one or more local networks, wherein the mobile communication network maintains access point information indicating the presence of a local network and broadcasts a system information message containing the access point information, and wherein the mobile station receives the system information message when camping on the mobile communication network and performs network search for a local network according to the access point information in the received system information message.

In a feature of the present invention, it is possible to improve the network search performance of a mobile station that supports heterogeneous networks including a mobile communication network and local network. The mobile station can check the presence of a local network on the basis of a system information message from the mobile communication network, and skip a network search if a local network is not present. Thereby, the mobile station can reduce power consumption due to unnecessary network search.

In the present invention, the mobile communication network maintains information regarding the presence of local networks within the coverage area, and periodically broadcasts a system information message containing local network information to mobile stations within the coverage area. Hence, a mobile station receiving the system information message can perform or skip local network search on the basis of the local network information in the system information message. That is, the mobile station can skip local network search in a location where a local network is not present. Hence, the mobile station can avoid unnecessary consumption of resources and time due to network search in a location where a local network is not present, reducing battery consumption.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network system according to an exemplary embodiment of the present invention;

FIG. 2 illustrates a sequence diagram for a network search procedure of a mobile station; and

FIG. 3 illustrates a flow chart for a network search method based on a system information message according to another exemplary embodiment of the present invention.

### DETAILED DESCRIPTION OF THE INVENTION

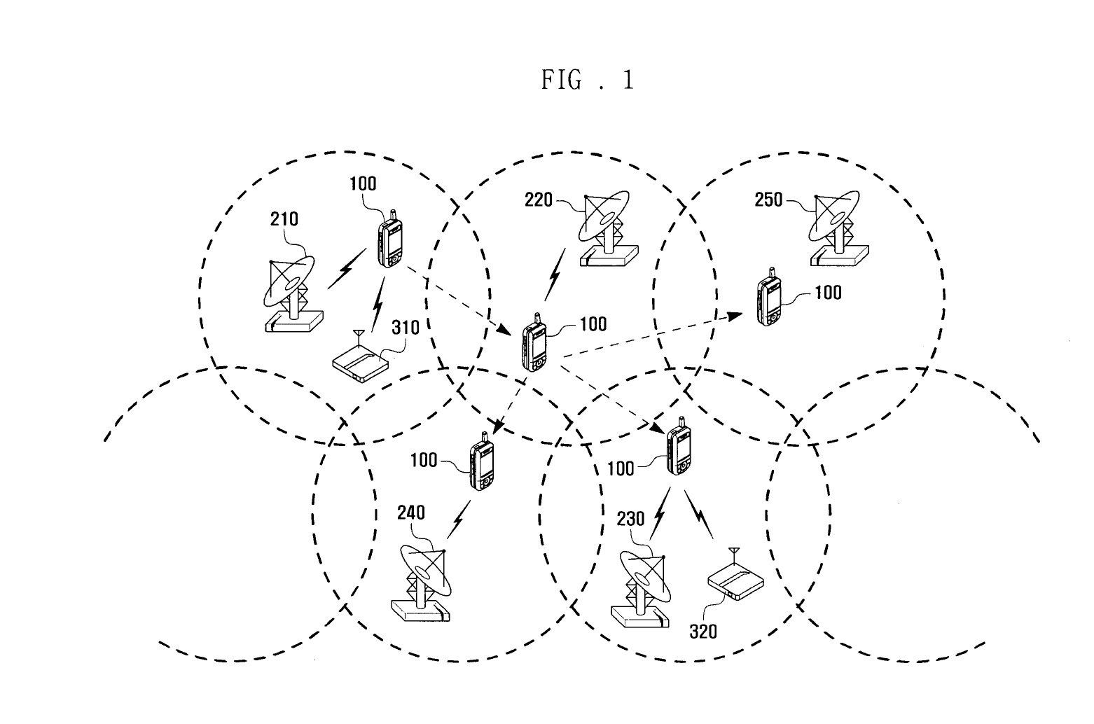

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

The present invention relates to a network search method for a multi-mode mobile station that supports heterogeneous networks including a mobile communication network and local network. The mobile communication network may be a GSM network, UMTS network, IMT-2000 network, CDMA network, or WCDMA network, and the local network may be a wireless local network such as IEEE 802.11 WLAN.

Next, a description is provided of the configuration of a network system and network search method.

FIG. 1 illustrates a wireless network system according to an exemplary embodiment of the present invention.

Referring to FIG. 1, the wireless network system can include a mobile station 100, a mobile communication network, and a local network.

As described above, the mobile communication network can be a network providing mobile communication services, such as a GSM network, UMTS network, IMT-2000 network, CDMA network, or WCDMA network. The mobile communication network can include base stations 210 to 250, which can communicate with the mobile station 100 to provide mobile communication services including voice, video and data communication services. Here, “Base station” is a representative term for Base Station, Base Transceiver Station (BTS), and Node-B. That is, the base stations 210 to 250 can refer to any type of base station specified in different mobile communication standards. The set of cells covered by the base stations 210 to 250 constitutes the mobile communication network.

As described before, a local network such as a WLAN can be installed in a selected cell of the mobile communication network. Local networks can be installed according to cell planning of the network operator.

A local network can include an access point 310 and 320, which can communicate with the mobile station 100 to provide IP-based services. A local network access point forms a cell with a specific coverage, and a local network cell can be included in a mobile network cell. That is, the coverage area formed by the access point 310 or 320 can be included in the coverage area formed by the base station 210 or 230. One mobile network cell can include multiple local network cells, or may not include any local network cell at all.

Each of the base stations 210 to 250 forming mobile network cells can make a radio link to the mobile station 100 to establish a communication channel according to a given communication scheme (for example, GSM, UMTS, IMT-2000, CDMA and WCDMA), and communicate with the mobile station 100 through the communication channel to provide a mobile communication service.

Each of the access points 310 and 320 forming local network cells can make a radio link to the mobile station 100 to establish a communication channel, and communicate with the mobile station 100 through the communication channel to provide an IP-based service.

The mobile station 100 can measure the signal level and signal quality of the mobile communication network and local network by the use of signals received from the base stations 210 to 250 of the mobile communication network and from the access points 310 and 320 of the local network, and determine the network providing the best channel environment (i.e., the optimum cell) on the basis of the measurement result. The procedure for selecting the optimal cell using received signals may be specified by the adopted standard.

In the above-described wireless network system, the mobile station 100 enters a mobile network cell that is determined to be optimal through a cell selection/reselection procedure, and connects to the mobile network cell (serving cell) through a radio access technology (RAT) employed by the cell. After connecting to the serving cell, the mobile station 100 can measure levels of down link signals from the serving cell and neighbor cells to select the optimum cell, and make a decision as to handover to the selected cell. The mobile station 100 can access one of the mobile communication network and the local network or perform inter-network handover for a continued service, on the basis of the selected cell.

As described above, the mobile station 100 can receive a mobile communication service through the mobile communication network, and receive an IP-based service related to Portable Internet or Voice over IP (VoIP) through the local network.

Compared with base stations of a mobile communication network, access points of a local network can be sparsely installed owing to cell planning. Hence, no local network access point may be present in a mobile network cell where the mobile station 100 currently is located. That is, a local network is not present in the mobile network cell at which the mobile station 100 currently is located.

The mobile station 100 can continue to perform local network search at a location where no local network access point is present. In the case when no local network is present, network search can entail a waste of processing time and unnecessary battery consumption due to useless search for a local network.

Hence, it is necessary to provide a network search method that enables a mobile station to reduce unnecessary battery consumption by skipping unnecessary network search and reducing network search time. Next, the network search method of the present invention is described in connection with FIG. 1.

Referring to FIG. 1, when a mobile station 100 enters and camps on a mobile network cell of the base station 210, the mobile station 100 can receive a system information message broadcast by the base station 210. The base station 210 broadcasts a system information message to all mobile stations within the coverage area.

Each of the base stations 210 to 250 broadcasts a system information message to all mobile stations within the coverage area (mobile network cell), and the system information message can contain a neighbor list specifying information regarding neighbor cells.

The system information message can further contain information regarding the presence of a local network such as a WLAN within the mobile network cell. That is, the system information message can contain information as to the presence of a local network access point (access point information) in the mobile network cell.

As described above, when the mobile station 100 camps on a mobile network cell, the mobile station 100 can receive a system information message broadcast by the corresponding base station. The system information message can contain access point information indicating the presence of a local network in the mobile network cell. A system information message containing access point information is illustrated in Table 1.

TABLE 1

<SI3 Rest Octet> ::= <Optional selection parameters>
<Optional Power offset>
<System Information 2ter Indicator>
<Early Classmark Sending Control >
<Scheduling if and where>
{ L | H <GPRSIndicator> }
<3G Early Classmark Sending Restriction>
{ L | H < SI2quater Indicator : < SI2quater Indicator struct > > }
<Iu Indicator> -- Conditional
<spare padding> :

Referring to Table 1, the system information message includes spare padding bits such as “SI3 rest octet”. In the present invention, a single bit of the spare bits named “wifi_present” can be used to convey the access point information as illustrated in Table 2.

TABLE 2

<wifi_present>
H : the available AP is present in this cell
L : the available AP is not present in this cell

The system information message of the present invention contains a “wifi_present” bit for the access point information, and the bit set to ‘H’ indicates presence of a local network and the bit set to ‘L’ indicates absence of a local network.

In the following description, for the access point information, the bit value ‘H’ denotes ‘true’ (presence of a local network) and the bit value of ‘L’ denotes ‘false’ (absence of a local network).

Each base station of the mobile communication network can maintain an access point map, which is prepared by the network operator and lists local network access points available to mobile stations within the mobile network cell. The base station can generate access point information on the basis of the preset access point map, and periodically broadcast a system information message containing the access point information to mobile stations.

As described herein above, the mobile station 100 can receive a system information message described in relation to Table 1 and Table 2 when camping on a mobile network cell. The mobile station 100 analyzes the received system information message and checks access point information in the system information message.

If the access point information is set to ‘true’, the mobile station 100 can be aware that a local network access point is present in the mobile network cell, and perform network search for a local network. If the access point information is set to ‘false’, the mobile station 100 can be aware that a local network access point is not present in the mobile network cell, and skip network search for a local network.

For example, in FIG. 1, the mobile station 100 performs network search for a local network and uses a service through the local network access point 310 or local network access point 320 only when the mobile station 100 enters and camps on the mobile network cell of the base station 210 or base station 230.

In FIG. 1, when the mobile station 100 enters and camps on the mobile network cell of the base station 220, base station 240 or base station 250, the mobile station 100 can skip a network search for a local network.

According to the present invention, each base station of a mobile communication network maintains a map of local networks present in the associated mobile network cell (access point information), and broadcasts a system information message containing the access point information to all mobile stations within the mobile network cell. When a mobile station camps on a particular mobile network cell, the mobile station can receive the system information message from the corresponding base station, and determine whether a local network is present in the mobile network cell by checking access point information in the system information message. On the basis of the determination, the mobile station can determine whether to perform a network search for a local network. Hence, the mobile station can reduce unnecessary processing and time for network search, and avoid unnecessary battery consumption.

Accordingly, the present invention provides a solution for the problem that a mobile station may experience unnecessary battery consumption due to repeated local network search in a mobile network cell that does not include a local network access point.

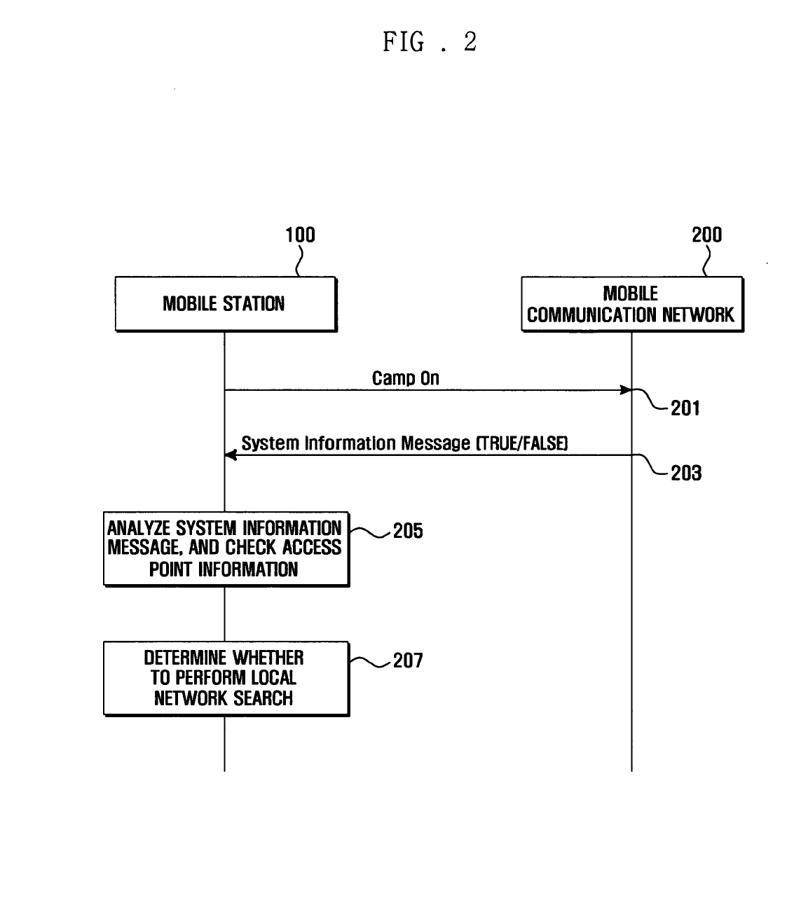

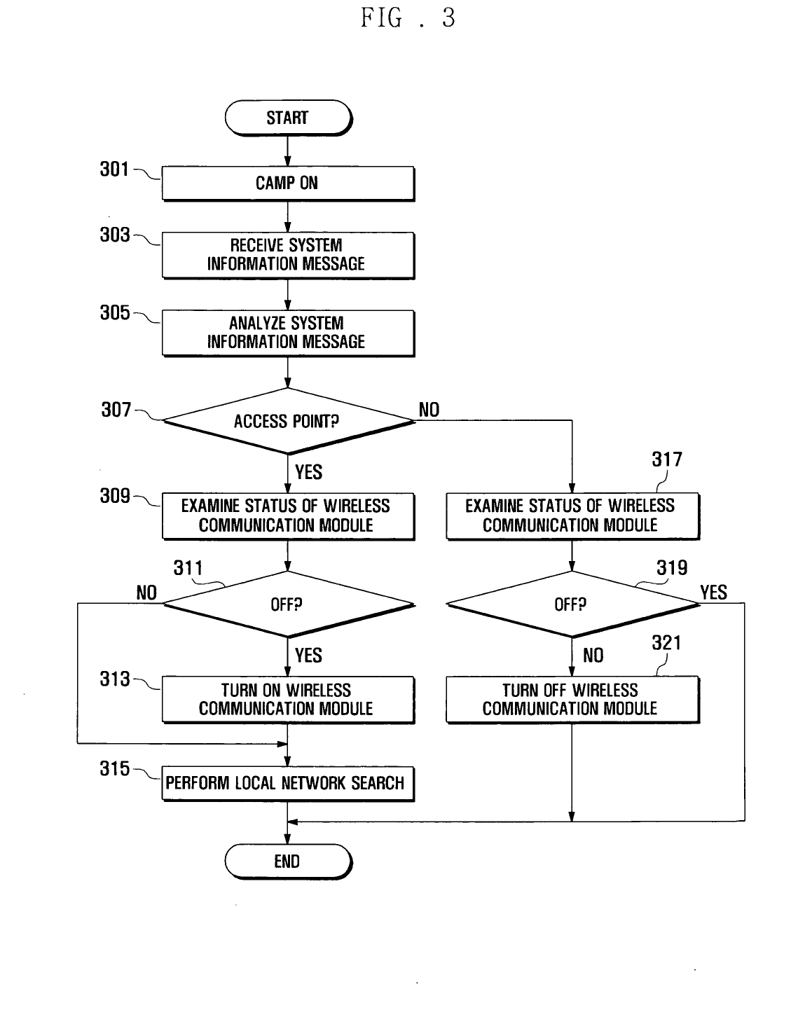

Next, operations related to reception of a system information message and decision as to network search are described in detail with reference to FIGS. 2 and 3. However, the present invention is not limited to these illustrations.

FIG. 2 is a sequence diagram illustrating a network search procedure of a mobile station. In FIG. 2, the mobile station obtains information regarding the presence of a local network from a received system information message, and determines whether to search a local network on the basis of the obtained information.

Referring to FIG. 2, a mobile station 100 camps on a cell of a mobile communication network 200 (step 201). The mobile station 100 receives a system information message broadcast by a base station of the mobile network cell (step 203). Each base station of the mobile communication network 200 broadcasts a system information message containing access point information to all mobile stations within the mobile network cell.

The mobile station 100 analyzes the received system information message and checks the access point information (step 205). The mobile station 100 determines whether to perform network search for a local network on the basis of the checking (step 207). That is, the mobile station 100 can determine whether to perform network search for a local network according to the value of the access point information (‘true’ or ‘false’), and perform a subsequent operation. These operations are described in detail with reference to FIG. 3.

FIG. 3 illustrates a flow chart for a network search method based on a system information message according to another exemplary embodiment of the present invention.

Referring to FIG. 3, a mobile station camps on a cell of a mobile communication network (block 301). The mobile station 100 receives a system information message broadcast by a base station of the camped-on mobile network cell (block 303), and analyzes the received system information message (block 305).

The mobile station determines whether a local network is present in the mobile network cell on the basis of the analysis result (block 307). The presence of a local network can be determined using the access point information (wifi_present) in the system information message.

If the access point information is set to ‘true’, the mobile station is aware that a local network access point is present in the mobile network cell, and examines the status of a wireless communication module (for example, an Internet communication module) connectable to the local network access point (block 309). If the wireless communication module is ‘off’ (block 311), the mobile station turns on the wireless communication module (block 313), and performs network search for a local network (block 315). If the wireless communication module is ‘on’ (block 311), the mobile station performs network search for a local network (block 315).

If the access point information is set to ‘false’ at block 307, the mobile station is aware that a local network access point is not present in the mobile network cell, and examines the status of the wireless communication module connectable to a local network access point (block 317). If the wireless communication module is ‘on’ (block 319), the mobile station turns off the wireless communication module (block 321), and skips network search for a local network. If the wireless communication module is ‘off’ (block 319), the mobile station skips network search for a local network.

The wireless communication module may be ‘on’ or ‘off’ depending upon the presence of a local network in the previous mobile network cell. Hence, the mobile station checks the status of the wireless communication module after camping on the current mobile network cell, and turns on or off the wireless communication module to perform or skip network search for a local network according to the access point information obtained from the current mobile network cell.

In an embodiment of the present invention, even when the network search mode is set to an auto-search mode, the mobile station can skip an unnecessary network search for a local network in a mobile network cell where a local network access point is not present. That is, the mobile station can skip a network search for a local network without controlling the wireless communication module, unlike the case of FIG. 3. Even when the network search mode is set to an auto-search mode, the mobile station also can control the wireless communication module in a particular mobile network cell, as in the case of FIG. 3. As described above, the mobile station can operate in various search modes.

The present invention can utilize the Global Positioning System (GPS), which has been commercially available in recent years. In this case, the mobile communication network can experience additional load by having to provide a mobile station with GPS information of available access points in a mobile network cell. The mobile station also can experience additional load by having to compute the distance for triggering network search on the basis of GPS information of itself and the available access points, and to measure GPS signals. Hence, to utilize the GPS, it is necessary to consider the complexity of implementation and additional load on the mobile communication network and mobile station.

As apparent from the above description in connection with FIGS. 1 to 3, the present invention provides an enhanced network search procedure that enables a mobile station to reduce battery consumption due to unnecessary network search with minimized additional load upon the mobile communication network and mobile station.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A network search method in a wireless communication system, the method comprising:
broadcasting, by a mobile communication network, a system in formation message containing access point information configured to indicate the presence of a local network (access point information); and
performing, after reception of the system information message, by a mobile station, network search for a local network according to the access point information.

2. The network search method of claim 1, wherein the mobile communication network maintains map information containing access point information set to ‘true’ when a local network access point is present in the coverage area, and maintains map information containing access point information set to ‘false’ when a local network access point is not present in the coverage area.

3. The network search method of claim 1, wherein performing network search for a local network comprises:
checking the access point information in the received system information message;
regarding, when the access point information is set to ‘true’, a local network access point is present, and determining to perform network search for a local network; and
regarding, when the access point information is set to ‘false’, a local network access point is absent, and determining to skip network search for a local network.

4. The network search method of claim 3, wherein performing network search for a local network further comprises performing network search for a local network through a wireless communication module connectable to the local network.

5. A network search method of a mobile station, the method comprising:
camping on a mobile network cell of a mobile communication network, and receiving a system information message broadcast from the mobile network cell;
checking access point information in the received system information message; and
determining whether to perform network search for a local network according to the value of the access point information.

6. The network search method of claim 5, wherein the system information message is based at least in part on map information maintained at a mobile communication network, the map information containing access point information set to ‘true’ when a local network access point is present, and the map information containing access point information set to ‘false’ when a local network access point is not present, and broadcasts a system information message containing the access point information.

7. The network search method of claim 6, wherein determining whether to perform network search for a local network comprises:
determining a local network access point to be present when the access point information is set to ‘true’, and performing network search for the local network; and
determining a local network access point to be absent when the access point information is set to ‘false’, and skipping network search for a local network.

8. The network search method of claim 7, wherein performing network search for the local network comprises:
checking the status of a wireless communication module connectable to the local network;
turning on, when the wireless communication module is ‘off’, the wireless communication module; and
performing network search for the local network through the wireless communication module.

9. The network search method of claim 7, wherein skipping network search for a local network comprises:
checking the status of a wireless communication module connectable to a local network; and
turning off, when the wireless communication module is ‘on’, the wireless communication module.

10. A wireless communication system comprising:
a mobile station;
a mobile communication network; and
one or more local networks,
wherein the mobile communication network maintains access point information indicating the presence of a local network and broadcasts a system information message containing the access point information, and
wherein the mobile station receives the system information message when camping on the mobile communication network and performs network search for a local network according to the access point information in the received system information message.

11. The wireless communication system of claim 10, wherein the mobile communication network maintains map information containing access point information set to ‘true’ when a local network access point is present, maintains map information containing access point information set to ‘false’ when a local network access point is not present, and broadcasts a system information message containing the access point information.

12. The wireless communication system of claim 10, wherein the mobile station regards, when the access point information is set to ‘true’, a local network access point to be present in the current cell, and performs network search for a local network.

13. The wireless communication system of claim 12, wherein the mobile station regards, when the access point information is set to ‘false’, a local network access point to be absent in the current cell, no network search for a local network is performed.

14. A mobile station comprising:
a receiver configured to receive a system information message broadcast from the mobile network cell when the mobile station camps on a mobile network cell of a mobile communication network; and
a processor configured to check access point information in the received system information message and determine whether to perform network search for a local network according to the value of the access point information.

15. The mobile station of claim 14, further comprising a global positioning system receiver configured to determine a location of the mobile terminal.

16. The mobile station of claim 15, wherein the system information message includes access point location information corresponding to the location of the mobile terminal.

17. The mobile station of claim 14, wherein when the access point information is set to ‘true’, a local network access point to be present in the current cell, the mobile station performs network search for a local network.

18. The mobile station of claim 17, wherein when the access point information is set to ‘false’ , a local network access point to be absent in the current cell, no network search for a local network is performed.

19. The mobile station of claim 17, wherein the processor checks the status of a wireless communication module, turns on the wireless communication module when the wireless communication module is ‘off’, and performs network search for the local network.

20. The mobile station of claim 17, wherein the processor is configured to check the status of a wireless communication module, and turns off the wireless communication module when the wireless communication module is ‘on’, and skips network search for a local network.
